(19) United States
(12) Patent Application Publication
(10) Pub. No.: US 2015/0254681 A1
(43) Pub. Date: Sep. 10, 2015

(54) METHOD, APPARATUS, AND COMPUTER PROGRAM PRODUCT FOR LEAD DEVELOPMENT, ASSESSMENT, AND MANAGEMENT

(71) Applicant: Move, Inc., Westlake Village, CA (US)

(72) Inventors: Tracy Mahnken, Danville, CA (US); Ryan Green, Richmond (CA); Warren Cree, Richmond (CA)

(21) Appl. No.: 14/640,596

(22) Filed: Mar. 6, 2015

Related U.S. Application Data
(60) Provisional application No. 61/949,533, filed on Mar. 7, 2014.

(51) Int. Cl. G06Q 30/02

(52) U.S. Cl. CPC G06Q 30/0201

(57) ABSTRACT

A method, apparatus and computer program product are provided for providing smart leads to responders. Leads may be ranked based on explicit information provided by an associated user, and/or implicit information collected by a system. Lead details may be generated to better assist the responder in understanding the lead's needs. A lead may be a prospective buyer, seller and/or tenant of real property, and the responder may be an agent, broker, and/or sales person. Actions responsive to received leads may be performed by the computer program system on behalf of the agent (in some cases including communications transmitted to the lead) and/or proposed by the system to the agent.

### CROSS REFERENCES TO RELATED APPLICATIONS

This application claims the benefit of priority to U.S. Provisional Application No. 61/949,533, filed Mar. 7, 2014, titled “Method, Apparatus, And Computer Program Product For Lead Development, Assessment, and Management,” and hereby incorporated by reference in its entirety.

### FIELD OF THE INVENTION

Various embodiments of the invention are related to lead development, assessment, and management technology. Specifically, embodiments relate to enhancing, assessing, and ranking leads and providing smart lead information to responders.

### BACKGROUND

Many businesses collect information from potential customers in an effort to better market goods and services to meet customer needs. In the age of the Internet, mobile devices and apps, social media, dynamic advertising technology, and Interactive Voice Response (IVR) systems, large amounts of information can be collected automatically, without the physical involvement of a sales representative and without the potential client intentionally contributing to such collection. Identification of a potential client is commonly referred to as a lead.

Leads may be generated in a number of ways. For example, a person may fill out a form on a webpage requesting information on an offering, such as a certain product or service. Similarly, that person may provide personal information by registering or completing a profile while accessing a particular webpage. As another example, the person may call a hotline associated with an offering, and information on that person's needs may be collected by a sales representative or through IVR. A sales management system may gather such information and generate leads.

Leads may be routed to a responder, such as a sales person, so the sales person may contact the person who is the subject of the lead in hopes of converting the lead to a client to generate new business. In some examples, a sales person may even pay a marketing service for access to leads based on the number of leads provided or may purchase a monthly membership to the marketing service, for example.

### BRIEF SUMMARY

A method, apparatus, and computer program product are therefore provided for ranking leads and providing smart lead information.

More specifically, a method is provided for providing a lead management system, the method comprising receiving prospect information comprising at least explicit and implicit information relating to a prospect, generating a lead based on the prospect information, wherein the lead comprises contact information for the prospect, a ranking of the lead, and a lead qualification summary, and determining a proposed method of follow-up by which to engage the prospect based at least in part on the prospect information.

In some examples, the implicit information comprises information relating to browser history on a user device, and the lead is ranked based on at least the browser history. In some examples, the method includes determining based on the prospect information, that the prospect is a prospective buyer and a prospective seller, wherein the lead is ranked based on the determination that the prospect is the prospective buyer and the prospective seller. In some examples, the method includes estimating a time frame for conversion of the lead to a sale based on the prospect information, wherein the ranking of the lead is based on at least the estimation of the time frame for conversion of the lead to a sale.

In some examples, the method includes estimating a monetary value associated with the lead based on the prospect information, wherein the ranking of the lead is based on at least the estimated monetary value. In some embodiments, the method further includes determining information regarding provision of the lead to multiple responders, wherein the ranking of the lead is based on the information regarding provision of the lead to multiple responders.

In some embodiments, the lead further includes a lead qualification summary describing the lead and being indicative of a quality of the lead.

A computer program product is also provided for developing, assessing, and managing leads, the computer program product comprising at least one non-transitory computer-readable medium having computer-readable program instructions stored therein, the computer-readable program instructions comprising instructions, which when performed by an apparatus, are configured to cause the apparatus to perform at least receiving prospect information comprising at least explicit and implicit information relating to a prospect, generating a lead based on the prospect information, wherein the lead comprises contact information for the prospect, a ranking of the lead, and determining a proposed method of follow-up by which to engage the prospect based at least in part on the prospect information.

An apparatus is also provided for developing, assessing, and managing leads the apparatus comprising processing circuitry configured to cause the apparatus to perform at least receiving prospect information comprising at least explicit and implicit information relating to a prospect, generating a lead based on the prospect information, wherein the lead comprises contact information for the prospect and a ranking of the lead, and determining a proposed method of follow-up by which to engage the prospect based at least in part on the prospect information.

An apparatus is also provided for developing, assessing, and managing leads the apparatus comprising means for receiving prospect information comprising at least explicit and implicit information relating to a prospect, means for generating a lead based on the prospect information, wherein the lead comprises contact information for the prospect and a ranking of the lead, and means for determining a proposed method of follow-up by which to engage the prospect based at least in part on the prospect information.

### BRIEF DESCRIPTION OF THE SEVERAL VIEWS OF THE DRAWINGS

FIG. 1 is a schematic representation of a system providing lead management, according to example embodiments;

FIG. 2 is a schematic representation of a lead management apparatus, according to example embodiments;

FIG. 3 is a flowchart illustrating operations for providing lead management, according to example embodiments;

FIG. 4 is an example display that may be provided according to example embodiments; and

FIG. 5 is an example display that may be provided according to example embodiments.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed, processed, and/or stored in accordance with various example embodiments. Thus, use of any such terms should not be taken to limit the spirit and scope of the disclosure. Further, where a computing device is described herein to receive data from another computing device, it will be appreciated that the data may be received directly from the other computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

### Overview

In some embodiments, a lead management apparatus may provide smart lead information such as lead rankings, lead qualification summaries, and/or proposed follow-up methods to a responder.

Although embodiments described herein are described with respect to responders who are real estate agents and/or brokers acting as sales persons (collectively referenced herein as “agents” and who receive leads relating to prospective buyers, sellers, and/or tenants of real property (collectively referenced herein as “prospects”), the method, apparatus, and computer program provided herein may be applicable to any industry involving marketing or sales and the creation and handling of leads. For example, although the description below relates mostly to leads in the context of real estate and sales, other examples may relate to fund raising activities or marketing of goods or service offerings that are free and not necessarily sold.

As used herein, the terms, “agent,” “real estate agent,” “broker,” and/or “sales person,” may include any individual entity, organization or group arranging, soliciting or promoting transactions, including as between a buyer, seller, and/or renter of real property. The real estate agent, broker or sales person may or may not receive a commission or other compensation for brokering, developing, or facilitating a transaction, thereby requiring a demand for leads. Leads may be routed to agents based on suitability, relevancy, or price paid for such leads. As an actual or potential recipient of leads and smart lead information, the agent may be considered a responder. Accordingly, the term “agent” should not be construed to limit the scope of the invention.

As used herein, the term, “lead” may include a data entity including any information associated with an individual or organization that may be a prospective client, such as party to a real estate transaction (e.g., potential buyer, seller, tenant, and/or the like). The lead may include identifying information of the prospect such as a name, pseudonym, user ID, residential or business address, email address, phone number, social media address and/or the like, so that an agent or other handler of the lead (e.g., the system described below) may contact or recognize the lead. Such information may be referred to as “prospect information,” and may include information describing a prospect such as information identifying the prospect and/or describing preferences, demographics, etc. of the prospect. As noted above, the term “prospect” may refer to a consumer, client, or potential client to an agent. The prospect may be considered the subject of the lead. In addition to information explicitly identifying or describing the prospect (whether or not the information was inputted or otherwise submitted by the prospect), the lead may also include smart lead information which may be information relating to the prospect and may be determined based on explicitly and/or implicitly provided or detected information according to embodiments described herein. The smart lead information may include rankings of various types, such as the degree of readiness of the prospect to make a purchase, and/or a qualification summary, according to embodiments described herein.

As used herein, the term “marketing service” may include any person, entity, or group, and/or any associated system, that submits, generates, surmises, or captures information regarding potential clients and that provides the leads to agents, and/or a third party system, and may also include combinations of one or more of these. In some examples, the marketing service may provide or involve an integrated search tool including or relating to properties listed or available for sale and/or for rent, among other information, for allowing or enticing potential customers to browse and/or search for properties. Information associated with the potential customers may be collected by the marketing service, which may generate leads and distribute the leads to agents and/or third party systems configured to distribute the leads to agents.

As noted above, a typical sales person may receive, such as from a sales management system, a number of leads and may not be able to, or may otherwise fail to, respond or timely respond to one or more of the leads received due to time constraints, difficulty distinguishing or evaluating the leads, or other reasons. In some instances, a lead may be more or less valuable to a particular sales person based on a variety of factors indicating a likelihood of converting the lead to a client and/or sale. For example, a sales person may receive 100 leads per week, with no additional information indicating which leads are likely to be converted, and which leads are not as likely to generate a sale. Without more information, a sales person may put off responding to the leads, or may be unable or unwilling to determine which leads to pursue or which leads to make a higher priority for responding. Therefore, improvements to existing sales management systems are desired.

Embodiments provided herein provide more efficient management of leads. The marketing service may collect more extensive information relating to prospects, which in turn may provide for ranking of leads based on value to an agent. The improved data collection and analysis of the leads may assist agents in more efficiently managing responses to leads, particularly when large numbers of leads are received in short time periods or when the time available to the agent for responding is very limited. Embodiments provided herein therefore offer improvements to sales management systems which may otherwise provide leads with no indication as to their likelihood of being converted to a sale.

Information collected by the marketing service and/or sales management system may include explicitly provided information, such as that provided by a potential customer upon registering with a website of the marketing service, submitting a lead-form, completing a profile, and/or the like. In some embodiments, the marketing service and/or sales management system may collect implicit information associated with the customer, such as search history, viewed properties, browsing history (including on websites, apps, or media other than those owned or operated by the proprietor of the marketing service), a detected location, and/or the like.

The information collected by the marketing service may therefore be processed and/or analyzed by the marketing service to improve the process by which agents receive leads, prioritize follow-up communication, and choose a method of following up on such leads. For example, ranking leads and providing smart lead information regarding the leads may assist agents in identifying which leads should be given a higher priority versus a lower priority for follow-up calls. In some examples, the marketing service may propose to an agent an action to take to follow-up on the lead, based on the information. In some embodiments, such as those in which the agent has permitted the marketing service to send communications on the agent's behalf, the marketing service may even automatically generate and/or transmit follow-up communications or take other actions to pursue the lead. Embodiments of the system described herein may be configured to do so in various ways, taking account of various policies, experience, judgment, preferences, and other factors.

### Example Embodiments

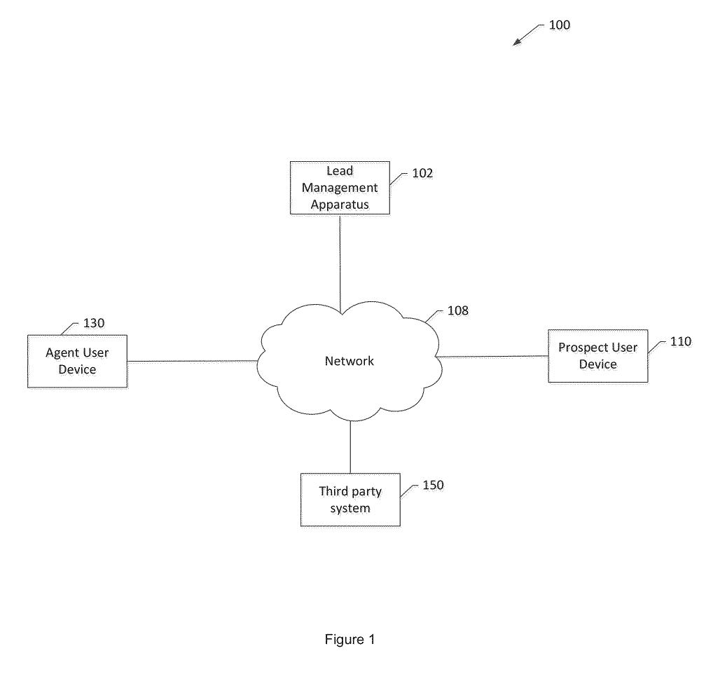

FIG. 1 is a block diagram of a system according to an example embodiment. It will be appreciated that the sales management system 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing lead development, assessment, and management, numerous other configurations may also be used to implement embodiments of the present invention.

The sales management system 100 may include a lead management apparatus 102 configured to communicate with any number of prospect user devices 110, agent user devices 130, and/or third party systems 150, among others. The lead management apparatus 102 may be configured to gather information regarding prospects (e.g., from the prospect user device 110), process the information, and provide leads to the agent user device(s) 130 and/or the third party system(s) 150. In some embodiments, the lead management apparatus 102 may be configured to attract prospect web traffic by various marketing and other methods. For example, the lead management apparatus 102 may provide integrated real estate listings from various third party systems 150, so that a prospect may search and browse such listings. Information regarding the prospects may therefore be collected and processed by the lead management apparatus 102, so as to provide smart lead management, as introduced above and described in further detail herein.

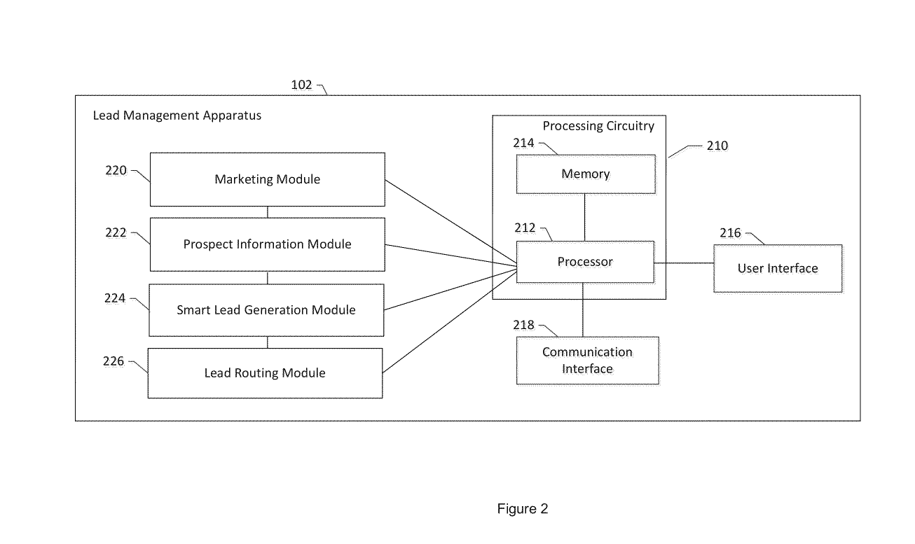

In some example embodiments, the lead management apparatus 102 may be embodied as or comprise one or more computing devices, such as, by way of non-limiting example, a server, configured to access a network 108. In some example embodiments, the lead management apparatus 102 may be implemented as a distributed system or a cloud based entity that may be implemented within the network 108. In this regard, the lead management apparatus 102 may comprise one or more servers, a server cluster, one or more network nodes, a cloud computing infrastructure, some combination thereof, or the like. An example lead management apparatus 102 is described in more detail with respect to FIG. 2 below.

With continued reference to FIG. 1, the prospect user device 110 may, for example, be embodied as a laptop computer, tablet computer, mobile phone, desktop computer, workstation, or other like computing device, and may be configured to provide information to the lead management apparatus 102. For example, the prospect user device 110 may be used by a prospect to access the lead management apparatus 102, such as for browsing real estate listings on a real estate website. Information relating to the prospect may therefore be collected by the lead management apparatus 102 as a result of the prospect's interaction with the prospect user device 110.

The sales management system 100 may include any number of agent user devices 130, which may, for example, be embodied as a laptop computer, tablet computer, mobile phone, desktop computer, workstation, or other like computing device, and may be used to access and/or receive leads provided by the lead management apparatus 102. A user of the agent user device 130 may therefore be a sales person, agent, and/or responder to the lead.

The prospect user device 110 and/or the agent user device 130 may be remote from the lead management apparatus 102, in which case the respective device may communicate with any apparatuses of sales management system 100 via the network 108. Additionally or alternatively, the prospect user device 110 and/or the agent user device 130 may be implemented on the lead management apparatus 102.

The third party system 150 may be any system, server, server cluster, apparatus, database and/or the like configured to communicate with any of the apparatuses of sales management system 100 over the network 108. Any number of third party systems 150 may be present. For example, the third party system 150 may provide real estate listings and/or other information to the lead management apparatus 102. The third party system 150 may include a system for receiving leads from the lead management apparatus 102 and, in turn, providing the leads to certain agent user device(s) 130, such as via a website or subscription service, for example. In some examples, the third party system 150 may provide prospect information and/or leads to the lead management apparatus 102, and the lead management apparatus 102 may generate a smart lead, assess and/or score the lead, and/or perform any other lead management operations as described with respect to example embodiments provided herein. In some examples, resulting smart lead information may be provided to the third party system 150. For example, the third party system 150 may be a system maintained by a real estate broker that generates leads via the broker's real estate website listings. Such leads, which may be conventional leads, may in turn be provided to the lead management apparatus 102, which may be configured to generate smart lead information (e.g., a ranking of the lead or other details, as described below) that may be sent back to the real estate broker (e.g., as a paid service to the real estate broker).

The lead management apparatus 102 may communicate with any of the apparatuses of sales management system 100 via any of a variety of methods dependent upon the configuration of the sales management system 100. For example, in embodiments in which the lead management apparatus 102 is disposed remotely from any of the apparatuses, information, such as prospect information, may be transmitted, via the network 108, by a variety of connections. Moreover, the lead management apparatus 102, the prospect user device 110, the agent user device 130, the third party system 150, and/or any component of the sales management system 100 may, in some embodiments, be configured according to policies, experience, judgment, preferences, and other factors, such as determined by the agent, certain defaults, certain local conventions, governing laws, etc.

The network 108 may be embodied in a local area network, the Internet, any other form of a network, or in any combination thereof, including proprietary private and semi-private networks and public networks. The network 108 may comprise a wireline network, wireless network (e.g., a cellular network, wireless local area network, wireless wide area network, some combination thereof, or the like), or a combination thereof, and in some example embodiments comprises at least a portion of the Internet. As another example, the lead management apparatus 102 may be directly coupled to any of the prospect user device 110, the agent user device 130, and/or the third party system 150.

An example embodiment of the lead management apparatus 102 is illustrated in FIG. 2. It should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

The lead management apparatus 102 may include processing circuitry 210, which may be configured to perform actions in accordance with one or more example embodiments disclosed herein. In this regard, the processing circuitry 210 may be configured to perform and/or control performance of one or more functionalities of the lead management apparatus 102 in accordance with various example embodiments. The processing circuitry 210 may be configured to perform data processing, application execution, and/or other processing and management services according to one or more example embodiments. In some embodiments, the lead management apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include a memory 214. The processing circuitry 210 may be in communication with or otherwise control a user interface 216, a communication interface 218, marketing module 220, prospect information module 222, smart lead generation module 224, and/or lead routing module 226. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the lead management apparatus 102 as described herein. The plurality of processors may be embodied on a single computing device or distributed across a plurality of computing devices collectively configured to function as the lead management apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry, such as in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the lead management apparatus 102. The memory 214 may be configured to store information, data, applications, instructions and/or the like for enabling the lead management apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets, such as information related to leads. Among the contents of the memory 214, applications may be stored for execution by the processor 212 to carry out the functionality associated with each respective application. In some cases, the memory 214 may be in communication with one or more of the processor 212, the user interface 216, the communication interface 218, and/or any of the modules 220, 222, 224, and 226 for passing information among components of the lead management apparatus 102.

In some example embodiments, the processor 212 (or the processing circuitry 210) may be embodied as, include, or otherwise control any of the marketing module 220, the prospect information module 222, the smart lead generation module 224, and/or the lead routing module 226. As such, the modules 220, 222, 224, and/or 226 may be embodied as various means, such as circuitry, hardware, a computer program product comprising computer readable program instructions stored on a computer readable medium (for example, the memory 214) and executed by a processing device (for example, the processor 212), or some combination thereof. The modules 220, 222, 224, and/or 226 may be capable of communication with one or more of the processor 212, the memory 214, the user interface 216, the communication interface 218, and the respective modules to access, receive, and/or send data as may be needed to perform one or more of the functionalities described herein.

For example, the marketing module 220 may be configured to provide a web interface providing information, such as real estate listings, to prospects so as to encourage prospects to access the lead management apparatus 102. The prospect information module 222 may be configured to collect prospect information, as described herein. The smart lead generation module 224 may be configured to utilize the prospect information to generate leads, rank leads, provide smart lead information, and/or the like, as described herein. The lead routing module 226 may direct the lead management apparatus 102 to provide a lead to an appropriate agent user device 130 and/or third party system 150 (shown in FIG. 1).

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of lead management operations and/or the like. In some example embodiments in which the lead management apparatus 102 is embodied as a server, cloud computing system, or the like, aspects of the user interface 216 may be limited or the user interface 216 may not be present. In some example embodiments, one or more aspects of the user interface 216 may be implemented on the agent user device 130 and/or the prospect user device 110 of FIG. 1. Accordingly, regardless of implementation, the user interface 216 may provide input and output means to facilitate lead management in accordance with one or more example embodiments.

The communication interface 218 may include one or more interface mechanisms for enabling communication between the lead management apparatus 102 and other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable the lead management apparatus 102 to communicate with various systems and/or apparatuses over the network 108. Accordingly, the communication interface 218 may, for example, include supporting hardware and/or software for enabling communications via cable, digital subscriber line (DSL), universal serial bus (USB), Ethernet, or other methods.

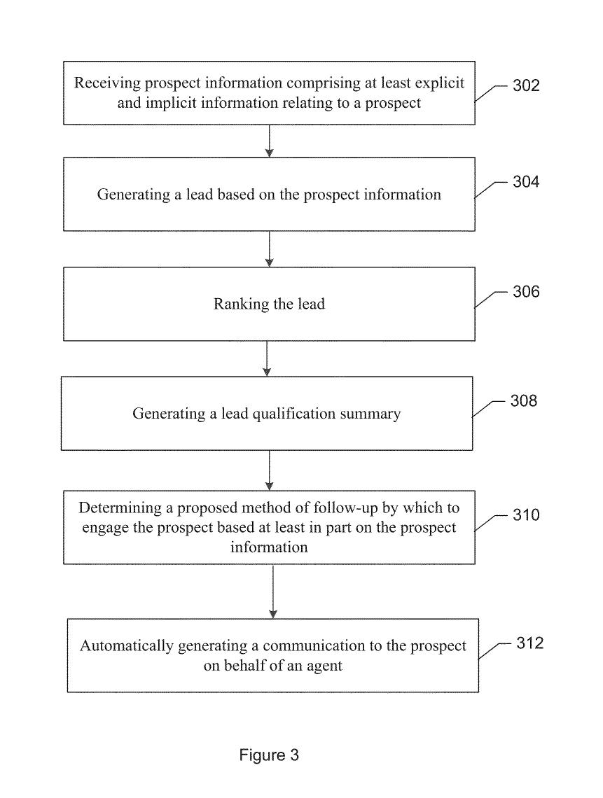

FIG. 3 is a flowchart of operations that may be performed by the lead management apparatus 102, according to example embodiments. As shown by operation 302, the lead management apparatus 102 may include means, such as the communication interface 218, the marketing module 220, the prospect information module 222, and/or the like for receiving prospect information comprising at least explicit and implicit information relating to a prospect. The prospect information may be provided by a prospect via the prospect user device 110 and/or the third party system 150, for example. In some embodiments, the marketing module 220 may generate a web interface by which the prospect information is gathered to be processed by the prospect information module 222.

The prospect information may include explicit information such as contact information, demographics, search criteria provided to the marketing module 220, and/or the like. For example, explicit prospect information may include a prospect name, phone number, address, email address, gender, age, income and/or the like. Such information may be considered to be explicitly provided to the marketing module 220, such as by creation of a user profile and/or registration with a website (e.g., a website provided by the marketing module 220). In this regard, explicit information may comprise information knowingly provided by a prospect for use by the lead management apparatus 102. Explicit information may thus be clearly and/or precisely defined for processing by the prospect information module 222.

In some embodiments, the prospect may provide search criteria relating to desired real estate listings, such as price range, bedroom count, bathroom count, square footage, and/or the like. Such search criteria may be considered explicit information. In some examples, the explicit information may include a free-form text input provided by the prospect, such as in response to a particular listing. For example, the prospect information may include, “I am looking for a 4 bedroom home in zip code 12345.” In some embodiments, explicit information may include a number of times the same prospect has been the subject of a lead provided to different agents.

Implicit information may also be collected by the marketing module 220. Implicit information may include any information provided by, inferred from, and/or detected based on a prospect's use of the prospect user device 110, for example. As such, the prospect may not be aware that such implicit information is collected.

For example, implicit information may include a prospect's browsing history, cookies, a detected location of the prospect or the prospect user device 110, a social media profile associated with the prospect, and/or the like. The implicit information may, for example, indicate that the prospect has searched for home loans, potentially providing a sign of a serious home buyer. For example, the lead management apparatus 102 may access the browsing history and categorize previous sites accessed by the prospect, including but not limited to third party sites not provided by the lead management apparatus 102. For example, browser history may be detected even if a prospect accesses sites external to the lead management apparatus 102. A prospect accessing a relatively large number of home buying related websites such as those related to financing, decorating, moving, etc., may be considered a serious home buyer, whereas a user not accessing many websites in categories relating to home buying may be considered a less serious home buyer. Implicit information, in some examples, may be gathered by the lead management apparatus 102 by initiating computer-driven research on other sources, such as remote databases, services (e.g., the third party system 150), and/or by accessing cookies stored on a prospect user device 110, for example. The computer-driven research may be performed based on explicit information relating to the prospect. For example, with a known name, email address, street address, and/or any other identifying information of a prospect, the lead management apparatus 102 may determine a prospect's political and/or religious affiliation, hobbies, familial status, income ranges, and/or the like based on computer-driven research. For example, the email address provided by a prospect in a lead may correspond to an email address used by the prospect for a social networking account containing additional information regarding the prospect. As another example, property records may indicate whether a prospect is a current home owner, and therefore may indicate whether the prospect is a prospective seller in addition to a prospective buyer. Such implicit information may assist the lead management apparatus 102 in assessing an associated lead, as described in further detail below.

As another example, the marketing module 220 and/or the prospect information module 222 may detect and/or otherwise store a location of the prospect. For example, a global position system (GPS) on a mobile prospect user device 110 may track real-time locations indicating that a prospect is driving in or through specific neighborhoods.

Information provided to third party social media networks from the prospect user device 110 may also be detected by the marketing module 220 and/or the prospect information module 222. For example, a prospect may share with friends life events such as obtaining a new job, becoming engaged to be married, having children, and/or the like, any of which may have strong correlations to purchasing and/or selling a home. An occupation of doctor as provided in a social network profile may indicate a higher price point of purchase and may useful for an agent to know.

In some examples, implicit information may include an amount of time spent searching for homes on a website provided by the marketing module 220. A prospect spending a significant amount of time searching may be considered a serious buyer and/or valuable lead. In some examples, implicit information may include a consistency score of searches conducted. For example, a prospect found to make repeated searches with consistent and/or similar criteria may be considered a serious buyer, whereas someone browsing or searching seemingly haphazardly, without consistency, may have a lower consistency score and may be identified as a less serious buyer. As yet another example, implicit information may include an indication that a prospect researched the value of a currently owned home (such as with the marketing module 220, and/or the third party system 150). The prospect may be considered a serious buyer and/or seller, due to the fact that the prospect may be a current home owner, and may have considerable equity in their home. In some examples, such implicit information may result in a higher ranking (as described below with respect to operation 306), on the basis of the prospect being a potential buyer and seller, and/or based on a relatively high purchase price in comparison to a first-time home buyer, for example. Tracking web or mobile application usage on an internal site of the lead management apparatus 102 may allow for precise tracking of every user selection, navigation, and/or click, and provide the lead management apparatus 102 with detailed usage information associated with the prospect. Therefore the implicit information may include app usage history and/or mobile usage history.

Regardless of the type of information collected, the prospect information module 222 may store the information, such as on the memory 214, in association with an identifier of the prospect such as an email address, for example.

As shown by operation 304, the lead management apparatus 102 may include means, such as the smart lead generation module 224, the processor 212, and/or the like, for generating a lead based on the prospect information. In some embodiments, the lead may include explicit information such as contact information for the prospect. The smart lead generation module 224, may in some examples, access and/or otherwise process information provided by the prospect information module 222. In some examples, this may include inferring smart lead information based on collected implicit information, as described herein. For example, in an instance in which implicit information indicates, such as via a social network, that a prospect is starting a new job in two months, the smart lead generation module 224 may generate smart lead information indicating a projected home search date one month away, and a projected home purchase date two months away.

In some examples, generating the lead may further comprise any of operations 306, 308, and/or 310 described below. In some embodiments, the lead may be generated and provided by the third party system 150, and the lead management apparatus 102 may further assess the lead as described below, with respect to operations 306, 308, and/or 310.

As shown by operation 306, the lead management apparatus 102 may include means, such as the smart lead generation module 224, the processor 212, and/or the like, for ranking the lead. In this regard, based on prospect information provided by the prospect information module 222, and/or smart lead information provided by the smart lead generation module 224, the smart lead generation module 224 may analyze information regarding the lead to determine how valuable a lead may be. For example, a lead having an associated prospect identified as being a likely home purchaser, such as based on explicit and/or implicit information, may be assigned a higher rating than a lead having an associated prospect identified as merely curious about houses on the market, but having no real intentions to purchase a home, such as a person found to have merely browsed a website provided by the marketing module 220 for a short period of time. As another example, a prospect identified as both a potential home buyer and seller (such as based on browser history, public records, and/or the like), may be considered a prospect for two transactions and thus may be considered more valuable than a home buyer who currently rents.

In some examples, leads may be ranked based on an estimation of a time frame for conversion of the lead to a sale. For example, if prospect information indicates a prospect will likely move in only a month as compared to another prospect who may move in 6 months, the prospect having the shorter time frame may be considered more valuable and may be ranked higher. The lead generation module 224 may estimate the time frame for conversion based on any of the prospect information, such as information on the prospect's social media page, purchase travel itineraries, and/or the like.

As another example, the lead generation module 224 may rank leads based on an estimated monetary value associated with the lead. The monetary value may be estimated based on a purchase price of a home and/or an estimated sales commission. For example, the prospect information may indicate that a prospect is looking at real estate listing for homes priced over $500,000. Such a prospect may be ranked higher than a prospect looking at homes priced at $200,000 and less.

In general, the ranking may be indicative of a likelihood that the lead will result in a sale. For example, a highly ranked lead may be highly likely to buy or sell real estate, or sign a leasing agreement.

Furthermore, in some embodiments, the lead generation module 224 may determine information regarding provision of the lead to multiple responders or agents and may rank the lead accordingly. For example, if a lead is provided to 4 other agents, the lead may be ranked highly such that a responder is encouraged to contact the lead as soon as possible before the other agents. As an alternative, in the same example scenario, the lead could be ranked lower because it may be determined that the receiving agent has less of a chance of converting a lead who has already been contacted by another agent.

In some embodiments, leads may be ranked according to a numeric score, such as a score of 1 to 100, or may alternatively be assigned a relative ranking of high, medium, or low, for example. In some embodiments, the leads may be ranked based on weighting of certain criteria. Explicit information may be given a higher weighting than implicit information, for example, since the implicit information may be determined to be a prediction or estimate made by the system, rather than presumably accurate and complete information entered by the prospect. In some embodiments, rankings may include an indication that the lead has exceeded some threshold minimum rating and/or score. For example, a lead having a score between 80 and 100 may be highlighted to the agent as a “hot lead,” such as by the use of different colors, text font, highlighting, flashing or moving text, icons, etc. In this way, an agent may be able to quickly (e.g., visually) discern which lead should receive higher priority for follow-up.

In some embodiments, formulas for determining lead rankings may be uniform across all leads known to the smart lead module 224. In some examples, leads may be ranked in comparison to only those leads provided to the same agent and/or group of agents. For example, an agent receiving 7 new leads in a day may receive the 7 leads ranked relative to each other. As such, an agent only having time to contact 3 leads per day may quickly identify the top 3 leads of the 7 leads provided that day.

In some embodiments, leads may be ranked based on compatibility between an agent and prospect. For example, a lead may be ranked after being assigned to a particular agent, such as by the lead routing module 226. Having identified the receiving agent of the lead, the smart lead module 224 may consider the agent's specialties and/or designations in ranking the lead. For example, having assigned a lead with a military background to an agent having a Military Relocation Professional designation, the smart lead module 224 may assign the lead a relatively high ranking, due to a predicted likelihood of the agent connecting with the prospect (e.g., on a personal or relationship level) by offering valuable information and demonstrating the agent's expertise that another agent may be unable to offer. Thus, in some cases, the same lead provided to two different agents may be assign two different rankings.

Lead rankings may be stored in association with other smart lead information, such as on the memory 214, and/or may be transmitted with the other smart lead information as directed by the lead routing module 226. Lead rankings may be considered smart lead information and may be provided to the agent with the associated prospect information. In some embodiments, the smart lead information may include some (e.g., selected) or all of the prospect information.

In still other embodiments, the lead management apparatus 102, such as via the smart lead generation module 224, the processor 212, and/or the like, may be configured to provide an alert to the agent that is indicative of the assigned ranking of the lead, one or more characteristics of the lead, or other prospect information. For example, an alert may be provided if the lead meets a certain threshold ranking indicating that it is a “hot” lead that should be prioritized for response by the agent. In another example, the alert may be provided based on the presence or absence of one or more particular characteristics in/from the prospect information or smart lead information. The characteristic(s) used as criteria may be predefined and/or pre-configured by the agent. For example, if the prospect was at an open house presided over by the agent within the last two weeks, or if the prospect has been in contact with a competing broker, then an alert may be provided. As such, the alert itself may be coded so as to convey a certain message to the agent. For example, different sounds, chimes, number of beeps, etc. may be used to indicate different underlying reasons for transmission of the alert. The agent may receive such alerts via the agent user device 130 (e.g., the agent's smartphone).

As shown by operation 308, the lead management apparatus 102 may include means, such as the smart lead generation module 224, the processor 212, and/or the like, for generating a lead qualification summary. A lead qualification summary may be any information, such as natural language text, describing the lead and/or reasoning for ranking. The lead qualification summary may incorporate explicit and/or implicit information selected by the smart lead generation module 224 as indicative of the quality of the lead (e.g., whether the lead is more likely less likely to result in a sale). An example lead qualification summary may be as follows:

“Suzy searched for a 4 bedroom home in the city of Albany, in the price range of $200,000 to $250,000. The estimated move date based on information from Suzy's social network profile is xx-xxxx (e.g., a month and year). This lead has been provided to 3 other agents in the past 2 weeks.”

As such, upon receiving a lead, including smart lead information such as a ranking and/or lead qualification summary as in the example above, an agent may be better able to discern the likelihood of a positive outcome with respect to the lead and may be able to determine appropriate follow-up steps for responding to the lead, based on the agent's experience, so as to maximize the likelihood of success. For example, the agent may choose to respond to one lead via email and to another lead via a phone call; the agent may respond to a certain lead before responding to others; or the agent may simply have a better idea for how to prepare for a conversation with a prospect, such as by conducting research specific to the prospect's search criteria. Additionally or alternatively, an agent may adjust a priority in responding to the lead based on the lead qualification summary. The lead qualification summary may be considered smart lead information and may be provided to an agent along with at least some of the prospect information and/or other smart lead information.

Continuing to operation 310, the lead management apparatus 102 may include means, such as the smart lead generation module 224, the processor 212, and/or the like, for determining a proposed method of follow-up by which to engage the prospect based at least in part on the prospect information. In the above example, the smart lead generation module 224 may suggest to an agent to send Suzy listings that meet her search criteria. In some embodiments, the smart lead generation module 224 may even make inferences based on implicit information. For example, if the prospect information module 222 provides information indicating a high likelihood of a prospect having children, the smart lead generation module 224 may suggest to an agent that the agent send the prospect school information and school district boundaries for the area of interest. As another example, the implicit information may suggest the optimal method of contacting the prospect, such as via a phone call, text message, email, etc. For example, the implicit information may indicate that the prospect is generally at her computer on weekdays between 10 AM and noon, suggesting that an email sent to the prospect in that timeframe would likely be seen promptly upon receipt. In some examples, a suggested method of follow-up may be identified based on a plurality of available follow-up methods.

In some examples, certain combinations of information may provide valuable insight to an agent. A location as indicated by an internet protocol (IP) address in combination with search criteria for properties in a faraway city may indicate that a lead may have a need for general information about neighborhoods and areas, as the lead may be relocating from another part of the country. A follow-up action may be proposed accordingly.

In an example where a lead has been identified as wanting to sell a house, the lead management apparatus 102 may propose to the agent that that agent prepare a comparative market analysis (CMA) to send to the lead. The above scenarios are provided merely as examples, and it will be appreciated that a proposed method of follow-up or proposed follow-up action may be provided based on any explicit and/or implicit information, and may include multiple variables, parameters, and/or information. In other words, the smart lead generation module 224 may be configured to receive and consider multiple inputs (e.g., multiple pieces of information, such as multiple items of prospect information) and determine, based on an analysis of these multiple variables, one or more proposed follow-up actions to the agent.

Similarly, continuing to operation 312, the lead management apparatus 102 may include means, such as the smart lead generation module 224, the processor 212, and/or the like, for automatically generating a communication to the prospect on behalf of the agent, such as email, text message, voice message, etc. For example, an agent may have a profile setup with the lead management apparatus 102, such as stored on the memory 214, for example, indicating preferences for the generation of automatic responses to leads. For example, the smart lead generation module 224 may generate and/or cause transmission of an email to the prospect associated with a lead. The email may include search results, and/or additional information regarding a neighborhood of interest, and/or the like. In some examples, the determined proposed method for follow-up, as described with respect to operation 310, may be automatically implemented. In some examples, the smart lead generation module 224 may apply information to stored templates, e.g., to generate an email or other communication to the prospect. An automatically generated communication to a prospect may include an agent's personal message (which may, for example, be preconfigured by the agent, during the agent's registration or profile completion) and/or the agent's contact information.

In some examples, the generated communication may be based on any of the explicit and/or implicit information. In some embodiments a method of communication may be determined based on a ranking and/or other smart lead information. For example, a prospect having a short time-frame for buying a house may receive an automatic text message, generated on behalf of an agent, when a new listing is located meeting the prospect's search criteria. In comparison, a lead having a longer time-frame may receive the automatic search results daily by email, or less frequently, such as weekly or monthly.

In such embodiments in which a communication is automatically generated, the smart lead module 224 may additionally provide the communication or notification of the communication to a receiving agent of the lead. Therefore, the agent may be aware of the automatic communications (e.g., their frequency and/or content), and can avoid overwhelming the prospect with too many or repetitive communications. Such embodiments may enable a quick automatic response soon after the lead is identified, but enable an agent to create a more personalized and/or targeted communication after having completed research on behalf of the prospect. For example, the lead qualification summary may include a sentence such as, “Suzy received an automatic email response on ‘xx-xx-xxxx’ (e.g., a date) including the following listings . . . ”

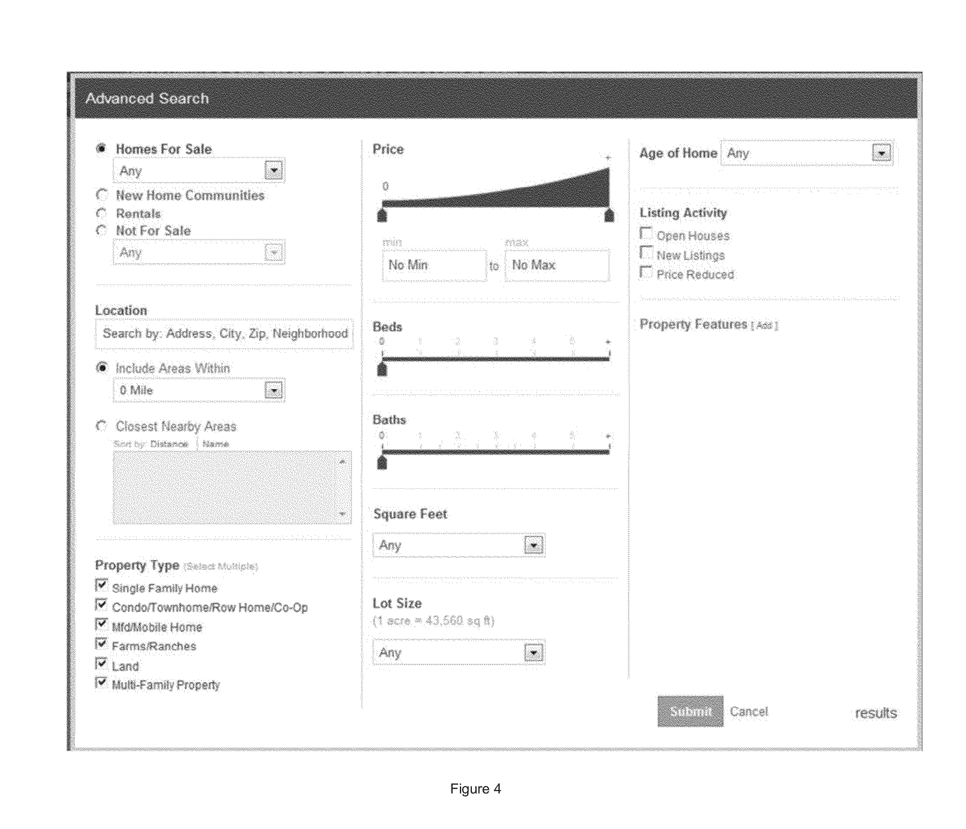

FIG. 4 is an example display that may be provided by the marketing module 220 to attract a prospect to access the lead management apparatus 102. A prospect, e.g., using the prospect user device 110, may provide search criteria on the display of FIG. 4. The search criteria may be stored as explicit data and may be used in the generation of smart lead information as described herein.

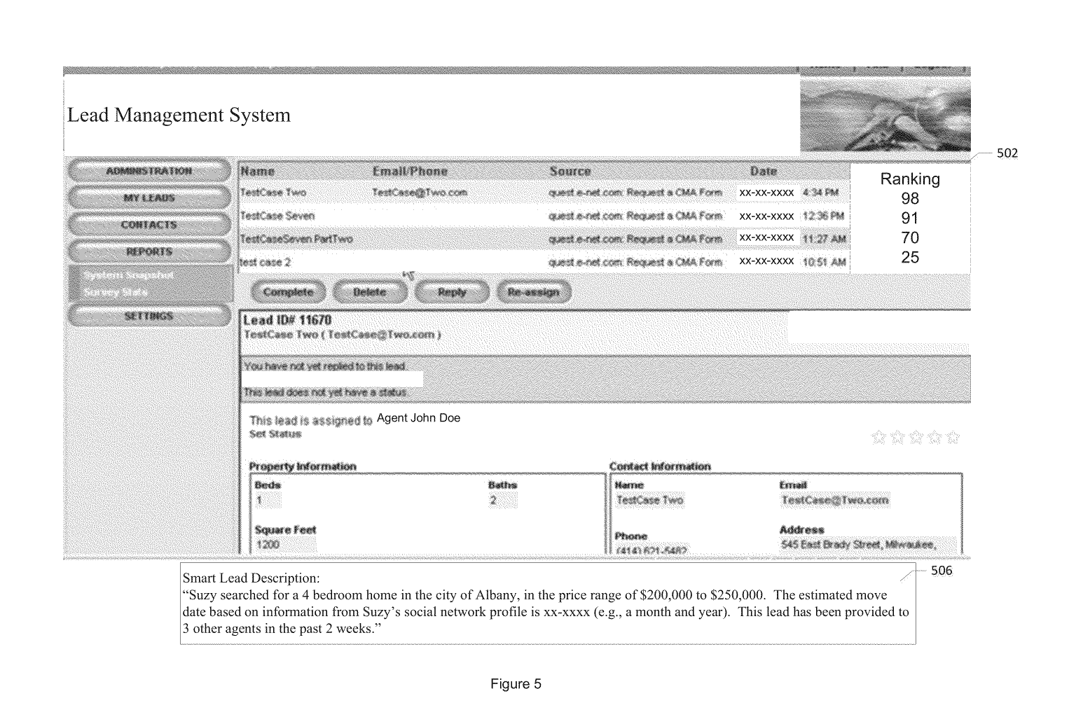

FIG. 5 is an example display that may be provided by the smart lead generation module 224 and/or the lead routing module 226, such as on the agent device 130 (and in some embodiments, via, the third party system 150). The example display provided leads to an agent, in a ranked order. The ranking for each respective lead may be provided in area 502. A lead qualification summary may be provided in area 506. An agent may use such a display for managing leads, prioritizing leads, and tracking communications with leads.

Any of the information regarding a lead, collected and/or generated as described above, such as smart lead information, may be provided to the agent user device 130 and/or the third party system 150 (which may in turn provide the lead to the agent user device 130). As described above, the smart lead information may include a ranking of the lead, selection and presentation of certain prospect information indicative of the quality or value of the lead, and/or proposed actions or method of follow-up. A receiving agent may therefore respond to a lead based on the information provided. The smart lead functionality described herein may help the agent make better decisions relating to how to communicate with a lead, what priority the lead should be given in comparison to other leads, and/or what the needs of the lead are.

The functionality provided by the lead management apparatus 102 may therefore result in more efficient time management related to lead follow-up and improved preparation by the agent prior to follow-up. Additionally, the improved preparation may impress a prospect and, therefore, result in higher prospect-to-client conversions. As such, some agents may be willing to pay a premium for smart leads as they recognize a positive impact to their income based on smart leads and smart lead management in comparison to conventional leads provided without any consideration to their value or likelihood of conversion. Thus, introducing a lead management apparatus according to example embodiments provided herein may provide improvements to existing sales management systems.

Furthermore, as the lead management apparatus 102 continues to gather and/or generate information, such as smart lead information described herein, any of the data may be stored in a database or similar device, for subsequent use and analysis. An extensive repository of smart lead information may enable the lead management apparatus 102 to provide improved smart lead information, such as more accurate rankings, improved proposed follow-up methods, and/or improved generated communications to prospects.

Furthermore, the method, apparatus, and computer program product provide numerous technical advantages including the conservation of processing resources and the associated power consumption otherwise expended by responders to further research conventional sales leads, such as via the Internet. According to embodiments provided herein, the extensive information including the prospect information, ranking, qualification summary, proposed method of follow-up, and/or the like reduces or eliminates the need for the responder to utilize additional processing resources to evaluate their leads. Furthermore, the lead management apparatus's ability to automatically generate and/or transmit communications to prospects on behalf of an agent reduces processing and memory resources required by the agent user device to otherwise store and/or transmit such communications on an individual basis.

As described above, FIG. 3 illustrates a flowchart of a system, method, and computer program product according to some example embodiments. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, the lead management apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, the lead management apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for developing, assessing, and managing leads with a lead management apparatus, the method comprising:
receiving prospect information comprising at least explicit and implicit information relating to a prospect, wherein the implicit information comprises information relating to at least one of browser history or application usage on a user device associated with the prospect;
generating a lead based on the prospect information, wherein the lead comprises contact information for the prospect and a ranking of the lead indicative of a likelihood that the lead will result in a sale; and
determining a proposed method of follow-up by which to engage the prospect based at least in part on the prospect information.

2. The method of claim 1, wherein the lead is ranked based on at least the browser history or the application usage.

3. The method of claim 1, further comprising:
determining, based on the prospect information, that the prospect is a prospective buyer and a prospective seller, wherein the lead is ranked based on the determination that the prospect is the prospective buyer and the prospective seller.

4. The method of claim 1, further comprising:
estimating a time frame for conversion of the lead to a sale based on the prospect information, wherein the ranking of the lead is based on at least the estimation of the time frame for conversion.

5. The method of claim 1, further comprising:
estimating a monetary value associated with the lead based on the prospect information, wherein the ranking of the lead is based on at least the estimated monetary value.

6. The method of claim 1, further comprising:
determining information regarding provision of the lead to multiple responders, wherein the ranking of the lead is based on the information regarding provision of the lead to multiple responders.

7. The method of claim 1, wherein the lead further comprises a lead qualification summary describing the lead and being indicative of likelihood that the lead will result in a sale.

8. A computer program product for developing, assessing, and managing leads, the computer program product comprising at least one non-transitory computer-readable medium having computer-readable program instructions stored therein, the computer-readable program instructions comprising instructions, which when performed by an apparatus, are configured to cause the apparatus to perform at least:
receiving prospect information comprising at least explicit and implicit information relating to a prospect, wherein the implicit information comprises information relating to at least one of browser history or application usage on a user device associated with the prospect;
generating a lead based on the prospect information, wherein the lead comprises contact information for the prospect and a ranking of the lead indicative of a likelihood that the lead will result in a sale; and
determining a proposed method of follow-up by which to engage the prospect based at least in part on the prospect information.

9. The computer program product of claim 8, wherein the lead is ranked based on at least the browser history or the application usage.

10. The computer program product of claim 8, wherein the computer-readable program instructions further comprise instructions, which when performed by the apparatus, are configured to cause the apparatus to perform at least:
determining, based on the prospect information, that the prospect is a prospective buyer and a prospective seller, wherein the lead is ranked based on the determination that the prospect is the prospective buyer and the prospective seller.

11. The computer program product of claim 8, wherein the computer-readable program instructions further comprise instructions, which when performed by the apparatus, are configured to cause the apparatus to perform at least:
estimating a time frame for conversion of the lead to a sale based on the prospect information, wherein the ranking of the lead is based on at least the estimation of the time frame for conversion.

12. The computer program product of claim 8, wherein the computer-readable program instructions further comprise instructions, which when performed by the apparatus, are configured to cause the apparatus to perform at least:
estimating a monetary value associated with the lead based on the prospect information, wherein the ranking of the lead is based on at least the estimated monetary value.

13. The computer program product of claim 8, wherein the computer-readable program instructions further comprise instructions, which when performed by the apparatus, are configured to cause the apparatus to perform at least:
determining information regarding provision of the lead to multiple responders, wherein the ranking of the lead is based on the information regarding provision of the lead to multiple responders.

14. The computer program product of claim 8, wherein the lead further comprises a lead qualification summary describing the lead and being indicative of the likelihood that the lead will result in a sale.

15. An apparatus for developing, assessing, and managing leads the apparatus comprising processing circuitry configured to cause the apparatus to perform at least:
receiving prospect information comprising at least explicit and implicit information relating to a prospect, wherein the implicit information comprises information relating to at least one of browser history or application usage on a user device associated with the prospect;
generating a lead based on the prospect information, wherein the lead comprises contact information for the prospect and a ranking of the lead indicative of a likelihood that the lead will result in a sale; and
determining a proposed method of follow-up by which to engage the prospect based at least in part on the prospect information.

16. The apparatus of claim 15, wherein the lead is ranked based on at least the browser history or the application usage.

17. The apparatus of claim 15, wherein the processing circuitry is further configured to cause the apparatus to perform at least:
determining based on the prospect information, that the prospect is a prospective buyer and a prospective seller, wherein the lead is ranked based on the determination that the prospect is the prospective buyer and the prospective seller.

18. The apparatus of claim 15, wherein the processing circuitry is further configured to cause the apparatus to perform at least:
estimating a time frame for conversion of the lead to a sale based on the prospect information, wherein the ranking of the lead is based on at least the estimation of the time frame for conversion.

19. The apparatus of claim 15, wherein the processing circuitry is further configured to cause the apparatus to perform at least:
estimating a monetary value associated with the lead based on the prospect information, wherein the ranking of the lead is based on at least the estimated monetary value.

20. The apparatus of claim 15, wherein the processing circuitry is further configured to cause the apparatus to perform at least:
determining information regarding provision of the lead to multiple responders, wherein the ranking of the lead is based on the information regarding provision of the lead to multiple responders.
